(19) United States
(12) Patent Application Publication
(10) Pub. No.: US 2025/0174961 A1
(43) Pub. Date: May 29, 2025

(54) OPTICAL AMPLIFIER AND OPTICAL AMPLIFICATION METHOD

(71) Applicant: NIPPON TELEGRAPH AND TELEPHONE CORPORATION, Tokyo (JP)

(72) Inventors: Takayuki KOBAYASHI, Musashino-shi (JP); Yutaka MIYAMOTO, Musashino-shi (JP); Masanori NAKAMURA, Musashino-shi (JP); Shimpei SHIMIZU, Musashino-shi (JP); Takeshi UMEKI, Musashino-shi (JP)

(73) Assignee: NIPPON TELEGRAPH AND TELEPHONE CORPORATION, Tokyo (JP)

(21) Appl. No.: 18/841,962

(22) PCT Filed: Mar. 2, 2022
(86) PCT No.: PCT/JP2022/008781

§ 371 Date: Aug. 27, 2024

(51) Int. Cl. H01S 3/23; H01S 3/10; H01S 3/30

(52) U.S. Cl. CPC H01S 3/2308; H01S 3/1003; H01S 3/30

(57) ABSTRACT

Provided is an optical amplifier that optically amplifies and relays an optical signal transmitted through an optical fiber transmission line, the optical amplifier including: an optical parametric amplification unit that performs optical parametric amplification on an input optical signal; and a Raman amplification unit that controls a gain so as to power-shift optimum input optical power in the optical fiber transmission line to a region where an output of the optical parametric amplification unit is linear amplification.

### TECHNICAL FIELD

The present invention relates to an optical amplifier and an optical amplification method.

### BACKGROUND ART

A current general wavelength multiplexing optical amplification relay transmission system is configured using a C band or an L band of 4 to 5 THz of a single wavelength band, and transmission capacity per system has been increased due to advancement of a transceiver (for example, see Non Patent Literature 1). However, the digital coherent technology has matured, and it is getting close to a stage where it is difficult to increase the capacity due to the advancement of transceivers, and it is important to increase the optical band in which wavelength multiplexing (widening of the bandwidth) can be performed.

Widening of the bandwidth of a conventional optical amplification relay transmission system is achieved by using a plurality of rare-earth doped optical fiber type amplifiers (erbium doped fiber amplifier (EDFA), bithmus doped fiber amplifier (BDFA), and the like) or semiconductor optical amplifiers (SOAs) corresponding to an optical band to be used, and in some cases, by combining with backward pump distribution Raman amplification capable of controlling an amplification band at a pump light wavelength using a transmission line itself as an amplification medium. In a conventional method, since the wavelength dependency of the gain and the noise figure is different for each amplifier to be used, there is a problem that the configuration of the optical amplification repeater and the transmission system design become complicated.

The rare-earth doped optical fiber type amplifier and the semiconductor optical amplifier have a problem in application to a future optical network that abundantly utilizes wavelength resources in which an increase or a decrease in the number of wavelengths is assumed, because there is a concern that an optical surge occurs due to a rapid fluctuation of input optical signal power, which causes deterioration of signal quality and damage to optical components. From such a background, application of optical parametric amplification to an optical amplification repeater capable of amplifying a polarization multiplexed signal and having excellent broadband performance and high-speed responsiveness has been studied (for example, see Non Patent Literature 2).

### CITATION LIST

### Non Patent Literature

Non Patent Literature 1: Kawasaki et al., “Beyond 100 G optical cross-connect (B100G-OXC) system no jitsuyouka (in Japanese) (Practical application of the Beyond 100 G optical cross-connect (B100G-OXC) system)”, NTT Technical Journal, https://journal.ntt.co.jp/article/14780 Non Patent Literature 2: Takayuki Kobayashi et al., “Wide-Band Inline-Amplified WDM Transmission Using PPLN-Based Optical Parametric Amplifier”, J. Lightwave Technol. 39, 787-794 (2021)

Non Patent Literature 3: T. Kobayashi et al., “13.4-Tb/s WDM Transmission over 1,280 km Repeated only with PPLN-based Optical Parametric Inline Amplifier”, 2021 European Conference on Optical Communication (ECOC), 2021, Tu4C1.3, doi: 10.1109/ECOC52684.2021.9605912.

### SUMMARY OF INVENTION

### Technical Problem

In a conventional EDFA, distortion does not occur in an optical signal in an operation region where a gain is saturated, but in an optical parametric amplifier (OPA), in a region where gain saturation occurs, the gain fluctuates according to the magnitude of an amplitude component of the optical signal due to its high-speed responsiveness, and distortion occurs in the signal. Therefore, it is difficult for the optical parametric amplifier to achieve both high gain and high output. In the optical amplification relay transmission in which only the conventional optical parametric amplifier is applied, when the input power to the transmission line fiber is increased to improve the signal-to-noise ratio, the signal is distorted due to gain saturation in the optical parametric amplifier, and the signal quality is deteriorated. Therefore, there is a problem that the signal quality after amplification is limited in a broadband amplification band covered by the optical parametric amplifier.

In view of the above circumstances, an object of the present invention is to provide a technology capable of performing broadband and high-quality optical amplification relay in optical amplification relay using optical parametric amplification.

### Solution to Problem

An aspect of the present invention is an optical amplifier that optically amplifies and relays an optical signal transmitted through an optical fiber transmission line, the optical amplifier including: an optical parametric amplification unit that performs optical parametric amplification on an input optical signal; and a Raman amplification unit that controls a gain so as to power-shift optimum input optical power in the optical fiber transmission line to a region where an output of the optical parametric amplification unit is linear amplification.

An aspect of the present invention is an optical amplification method in an optical amplifier that optically amplifies and relays an optical signal transmitted through an optical fiber transmission line, the optical amplification method including: performing optical parametric amplification on an input optical signal by an optical parametric amplification unit; and controlling a gain so as to power-shift optimum input optical power in the optical fiber transmission line to a region where an output of the optical parametric amplification unit is linear amplification.

### ADVANTAGEOUS EFFECTS OF INVENTION

According to the present invention, it is possible to perform broadband and high-quality optical amplification relay in optical amplification relay using optical parametric amplification.

### BRIEF DESCRIPTION OF DRAWINGS

FIG. 1 A diagram illustrating a configuration example of an optical transmission system in the present invention.

FIG. 2 A diagram for describing a basic configuration example of an optical amplifier in the present invention.

FIG. 3 A diagram for describing an effect in a case where optical parametric amplification and Raman amplification of forward pump are combined.

FIG. 4 A diagram for describing an effect in a case where optical parametric amplification and Raman amplification of forward pump are combined.

FIG. 5 A diagram illustrating an exemplary configuration of an optical amplifier in a first embodiment.

FIG. 6 A flowchart illustrating a flow of processing performed by the optical amplifier in the first embodiment.

FIG. 7 A diagram illustrating an exemplary configuration of an optical amplifier in a second embodiment.

FIG. 8 A flowchart illustrating a flow of processing performed by the optical amplifier in the second embodiment.

FIG. 9 A diagram for describing effects in the first embodiment and the second embodiment.

FIG. 10 A diagram illustrating an exemplary configuration of an optical amplifier in a third embodiment.

### DESCRIPTION OF EMBODIMENTS

Hereinafter, an embodiment of the present invention will be described with reference to the drawings.

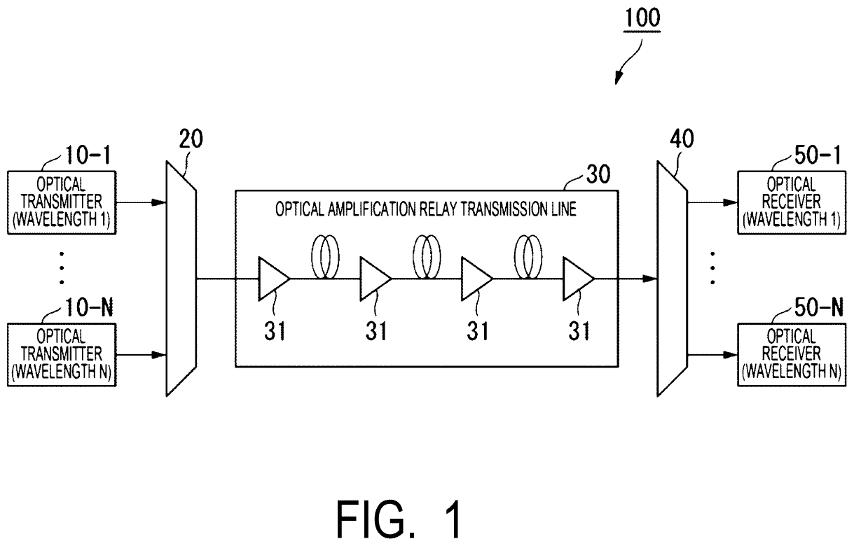

FIG. 1 is a diagram illustrating a configuration example of an optical transmission system 100 in the present invention. The optical transmission system 100 includes a plurality of optical transmitters 10-1 to 10-N (N is an integer of 2 or more), an optical multiplexer/demultiplexer 20, an optical amplification relay transmission line 30, an optical multiplexer/demultiplexer 40, and a plurality of optical receivers 50-1 to 50-N. The optical amplification relay transmission line 30 includes one or more optical amplifiers 31 and an optical fiber transmission line.

The optical transmitters 10-1 to 10-N transmit optical signals of different wavelengths. For example, the optical transmitter 10-1 transmits an optical signal of wavelength 1, and the optical transmitter 10-N transmits an optical signal of wavelength N.

The optical multiplexer/demultiplexer 20 multiplexes optical signals having different wavelengths transmitted from the optical transmitters 10-1 to 10-N by wavelength division multiplexing to generate a WDM signal. The optical multiplexer/demultiplexer 20 outputs the generated WDM signal to the optical amplification relay transmission line 30.

The optical amplifier 31 amplifies and transmits the WDM signal output from the optical multiplexer/demultiplexer 20. More specifically, the optical amplifier 31 performs optical parametric amplification and Raman amplification on the WDM signal.

The optical multiplexer/demultiplexer 40 demultiplexes the WDM signal amplified by the optical amplifier 31. For example, the optical multiplexer/demultiplexer 40 demultiplexes the WDM signal into optical signals having wavelengths of 1 to N and outputs the optical signals to the optical receivers 50-1 to 50-N.

The optical receivers 50-1 to 50-N receive the optical signals demultiplexed by the optical multiplexer/demultiplexer 40. For example, the optical receiver 50-1 receives an optical signal of wavelength 1, and the optical receiver 50-N receives an optical signal of wavelength N.

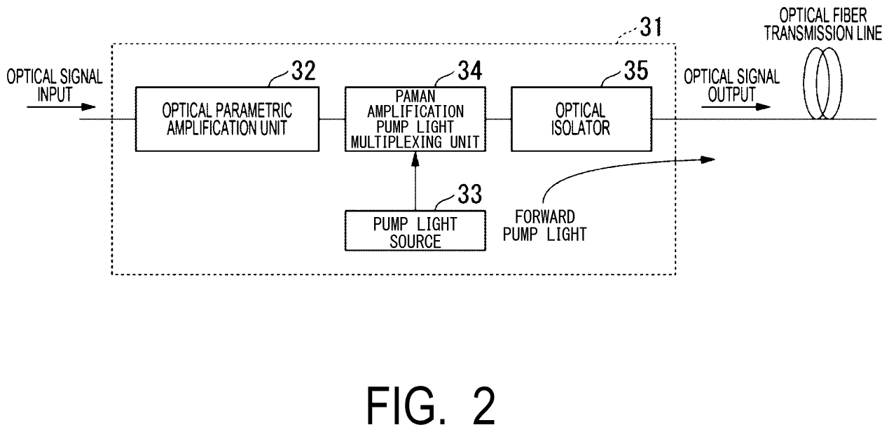

FIG. 2 is a diagram for describing a basic configuration example of an optical amplifier 31 in the present invention. The optical amplifier 31 includes an optical parametric amplification unit 32, a pump light source 33, a Raman amplification pump light multiplexing unit 34, and an optical isolator 35.

The optical parametric amplification unit 32 includes, for example, a highly nonlinear fiber and a periodically poled lithium niobate (PPLN) waveguide. The optical parametric amplification unit 32 amplifies the input optical signal using the nonlinear optical effect.

The pump light source 33 outputs pump light having a predetermined wavelength and intensity. The wavelength of the pump light output from the pump light source 33 is set on the basis of the wavelength of the optical signal input to the optical amplifier 31.

The Raman amplification pump light multiplexing unit 34 performs Raman amplification of forward pump on the basis of the optical signal amplified by the optical parametric amplification unit 32 and the pump light output from the pump light source 33. The Raman amplification pump light multiplexing unit 34 controls the gain so as to power-shift the optimum input optical power in the optical fiber transmission line to a region where the output of the optical parametric amplification unit 32 is linear amplification.

The optical isolator 35 transmits light traveling in the forward direction and blocks light in the reverse direction. For example, the optical isolator 35 transmits light traveling to the optical fiber transmission line and blocks input of light in the direction of the Raman amplification pump light multiplexing unit 34.

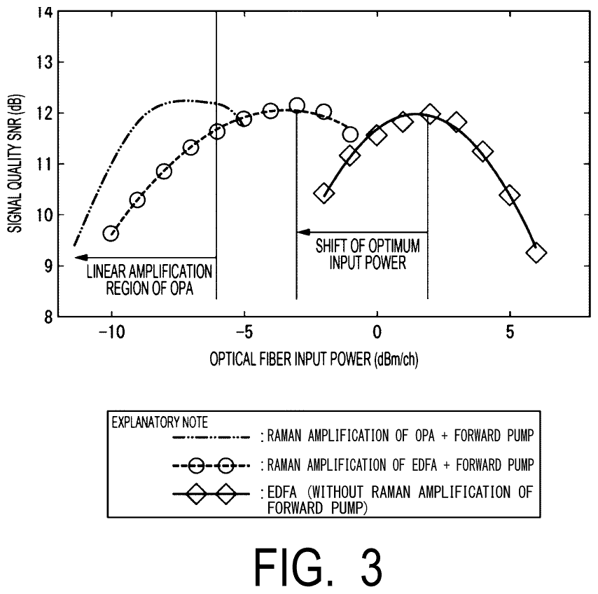

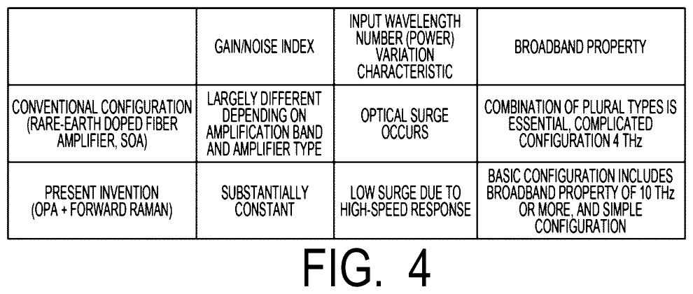

The basic configuration of the optical amplifier 31 according to the present invention is as described above. The effect in a case where optical parametric amplification and Raman amplification of forward pump are combined as described above will be described. FIGS. 3 and 4 are diagrams for describing an effect in a case where optical parametric amplification and Raman amplification of forward pump are combined. FIG. 3 illustrates a measurement example of the relationship between the quality (SNR) of the optical signal and the optical fiber input power when the optical amplification relay transmission is performed for 2,000 km with the configuration of the amplifier illustrated in the explanatory note. FIG. 4 illustrates a comparison result of the present invention with a conventional configuration regarding a gain/noise index, a variation characteristic of the number of input wavelengths (power), and wideband characteristics.

As illustrated in FIG. 3, by applying Raman amplification of the forward pump (distributed Raman amplification of the forward pump) to the amplifier (EDFA), the upper limit value of the signal quality is substantially equivalent, but the optimum input power shifts to a low region. The shift amount of the optimum power can be controlled by the gain of the Raman amplification of the forward pump. By controlling the gain of the Raman amplification of the forward pump up to the linear amplification region of the optical parametric amplifier as in the present invention using the characteristic of the optimum power shift by the Raman amplification of the forward pump, it is possible to perform broadband optical amplification relay with high signal quality without impairing the wideband property and high-speed responsiveness of the optical parametric amplification. As described in Reference Literature 1 below, when a pump light source with high coherency is used for forward pump distribution Raman amplification, signal quality is greatly deteriorated due to the influence of RIN transfer at a certain Raman gain or more. Therefore, in some embodiments, it is desirable to use an incoherent light source with an expanded optical spectrum as a forward pump light source.

(Reference Literature 1: Takayuki Kobayashi, Masahito Morimoto, Haruki Ogoshi, Shigehiro Takasaka, Junji Yoshida, Yutaka Miyamoto, “2nd-order forward-pumped distributed Raman amplification employing SOA-based incoherent light source in PDM-16QAM WDM transmission system”, IEICE Communications Express, Vol. 8, No. 5, p. 166-171, 2019.)

The configuration illustrated in FIG. 2 is a configuration of the optical amplifier 31 capable of amplifying and relaying an optical signal of one wavelength, and a configuration of the optical amplifier 31 capable of amplifying and relaying a plurality of wavelength-multiplexed optical signals will be described using the above-described principle.

### First Embodiment

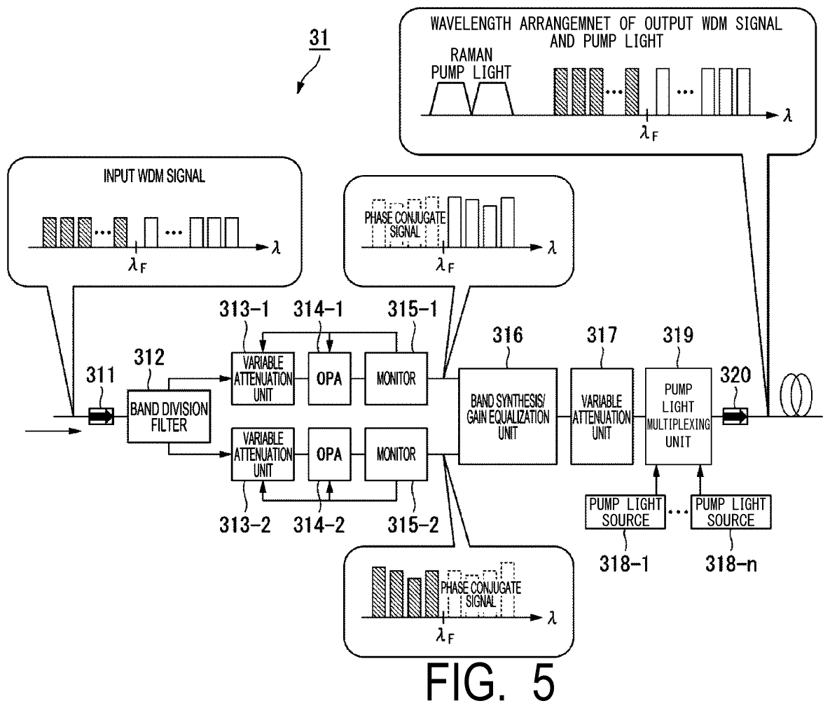

FIG. 5 is a diagram illustrating an exemplary configuration of an optical amplifier 31 in a first embodiment. The optical amplifier 31 includes an optical isolator 311, a band division filter 312, a plurality of variable attenuation units 313-1,313-2, a plurality of OPAs 314-1,314-2, a plurality of monitors 315-1,315-2, a band synthesis/gain equalization unit 316, a variable attenuation unit 317, a plurality of pump light sources 318-1 to 318-n (n is an integer of 2 or more), a pump light multiplexing unit 319, and an optical isolator 320. A WDM signal is input to the optical amplifier 31. The configuration illustrated in FIG. 5 can be applied as an optical amplification relay unit and a post-amplifier.

The optical isolator 311 transmits light traveling in the forward direction and blocks light in the reverse direction. For example, the optical isolator 311 transmits light traveling to the band division filter 312 and blocks input of light in a direction toward the optical fiber transmission line.

The band division filter 312 divides the input WDM signal into two bands. Specifically, for example, the band division filter 312 divides the WDM signal into an optical signal in a long wavelength band and an optical signal in a short wavelength band with reference to a basic wavelength λ_{F} by the band division filter 312. By the band division filter 312, the optical signal in the long wavelength band is output to the variable attenuation unit 313-1, and the optical signal in the short wavelength band is output to the variable attenuation unit 313-2.

When the input signal is amplified by the OPA, the phase conjugate light (idler light) generated around the basic wavelength λ_{F} in the process of the optical parametric amplification is unnecessary. Therefore, the WDM signal is divided into two bands by the band division filter 312 and amplified by the OPAs 314-1 and 314-2. When the pump light for distributed Raman amplification is included in the input signal (WDM signal), the band division filter 312 and the pump light removal filter of FIG. 5 are separately arranged on the input side of the optical amplifier 31, and the pump light for forward Raman amplification is separated and removed from the WDM signal.

The variable attenuation unit 313-1 adjusts the power of the optical signal in the long wavelength band. In the variable attenuation unit 313-1, the attenuation amount by the variable attenuation unit 313-1 is set on the basis of the monitoring result of the output power of the OPA 314-1 by the monitor 315-1, and the power of the optical signal in the long wavelength band input to the OPA 314-1 is adjusted.

The variable attenuation unit 313-2 adjusts the power of the optical signal in the short wavelength band. In the variable attenuation unit 313-2, the attenuation amount by the variable attenuation unit 313-2 is set on the basis of the monitoring result of the output power of the OPA 314-2 by the monitor 315-2, and the power of the optical signal in the short wavelength band input to the OPA 314-2 is adjusted.

The OPA 314-1 includes, for example, a highly nonlinear fiber and a periodically poled lithium niobate (PPLN) waveguide. The OPA 314-1 amplifies the input optical signal using the nonlinear optical effect. For example, the OPA 314-1 amplifies a WDM signal in a long wavelength band. In the OPA 314-1, the pump light level of the OPA 314-1 is set on the basis of the monitoring result of the output power of the OPA 314-1 by the monitor 315-1, and amplification is performed at the set pump light level.

The OPA 314-2 includes, for example, a highly nonlinear fiber and a periodically poled lithium niobate waveguide. The OPA 314-2 amplifies the input optical signal using the nonlinear optical effect. For example, the OPA 314-2 amplifies a WDM signal in a short wavelength band. In the OPA 314-2, the pump light level of the OPA 314-2 is set on the basis of the monitoring result of the output power of the OPA 314-2 by the monitor 315-2, and amplification is performed at the set pump light level.

The monitors 315-1, 315-2 monitors output power of the OPA 314-1, 314-2 in order to perform gain saturation control of the OPA 314-1, 314-2. An operation area where gain saturation occurs with respect to pump light and input signal power of the OPA 314-1, 314-2 can be obtained by measuring in advance or detecting distortion in a receiver of an optical transmission system.

The band synthesis/gain equalization unit 316 synthesizes the WDM signal of the long wavelength band in which the optical power is amplified by the OPA 314-1 and the WDM signal of the short wavelength band in which the optical power is amplified by the OPA 314-2. Thereafter, the band synthesis/gain equalization unit 316 performs gain equalization.

The variable attenuation unit 317 adjusts the input power of the WDM signal output from the band synthesis/gain equalization unit 316.

The pump light sources 318-1 to 318-n output pump light of different wavelengths. As the pump light sources 318-1 to 318-n, those having a wavelength band shifted to a short wavelength side of about 100 nm with respect to the WDM signal are used. In order to avoid signal quality degradation due to RIN transfer, it is preferable to use an incoherent light source in a region of multi-relay transmission or high Raman amplification gain. Multiple wavelengths may be bundled including a light source for polarization multiplexing or secondary pump. The Raman amplification gain of the forward pump is set to the output of the pump light source such that the optimum optical fiber input power is included in the non-gain saturation region of the OPA 314-1 and 314-2.

The pump light multiplexing unit 319 multiplexes the pump light output from each of the pump light sources 318-1 to 318-n and the WDM signal.

The optical isolator 320 transmits light traveling in the forward direction and blocks light in the reverse direction. For example, the optical isolator 320 transmits light traveling to the optical fiber transmission line and blocks input of light in the direction toward the pump light multiplexing unit 319.

The gain of the optical amplification repeater is set such that the sum of the forward Raman gain GRF and the gain GOPA by the OPA is equal to the loss of the transmission line to be relayed.

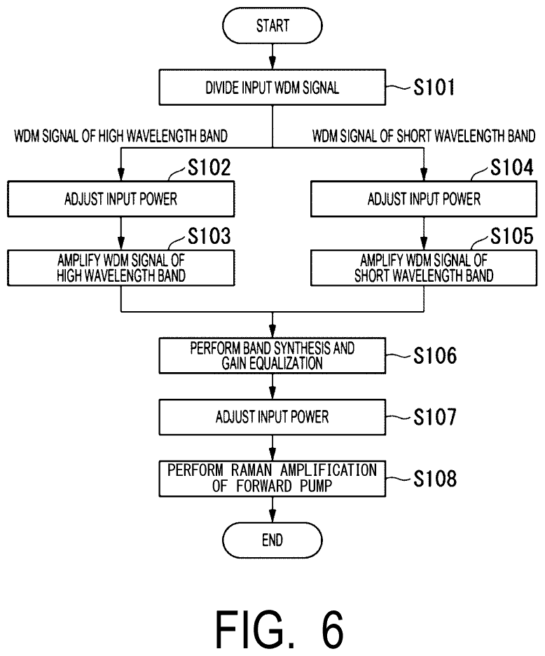

FIG. 6 is a flowchart illustrating a flow of processing of the optical amplifier 31 in the first embodiment.

The band division filter 312 divides the input WDM signal into two bands (step S101). By the band division filter 312, the divided optical signal in the long wavelength band is output to the variable attenuation unit 313-1, and the optical signal in the short wavelength band is output to the variable attenuation unit 313-2. The variable attenuation unit 313-1 adjusts the power of the optical signal in the long wavelength band (step S102). The variable attenuation unit 313-1 outputs the optical signal in the long wavelength band after the power adjustment to the OPA 314-1. The OPA 314-1 amplifies a WDM signal in a long wavelength band (step S103). The OPA 314-1 outputs the amplified WDM signal in the long wavelength band to the band synthesis/gain equalization unit 316 via the monitor 315-1.

The monitor 315-1 monitors the output power of the amplified WDM signal in the long wavelength band output from the OPA 314-1. The feedback control on the variable attenuation unit 313-1 and the OPA 314-1 based on the monitoring result by the monitor 315-1 is executed every time the monitoring result is obtained.

The variable attenuation unit 313-2 adjusts the power of the optical signal in the short wavelength band (step S104). The variable attenuation unit 313-2 outputs the optical signal in the short wavelength band after the power adjustment to the OPA 314-2. The OPA 314-2 amplifies a WDM signal in a short wavelength band (step S105). The OPA 314-2 outputs the amplified WDM signal in the short wavelength band to the band synthesis/gain equalization unit 316 via the monitor 315-1.

The monitor 315-2 monitors the output power of the amplified WDM signal in the long wavelength band output from the OPA 314-2. The feedback control on the variable attenuation unit 313-2 and the OPA 314-2 based on the monitoring result by the monitor 315-2 is executed every time the monitoring result is obtained.

The band synthesis/gain equalization unit 316 performs synthesis and gain equalization of the WDM signal in the long wavelength band in which the optical power is amplified by the OPA 314-1 and the WDM signal in the short wavelength band in which the optical power is amplified by the OPA 314-2 (step S106). The WDM signal synthesized and gain-equalized by the band synthesis/gain equalization unit 316 is input to the variable attenuation unit 317. The variable attenuation unit 317 adjusts the input power of the WDM signal (step S107). The variable attenuation unit 317 outputs the WDM signal after the input power adjustment to the pump light multiplexing unit 319.

The pump light multiplexing unit 319 performs Raman amplification of the forward pump by combining the pump light output from each of the pump light sources 318-1 to 318-n and the WDM signal (step S108). The WDM signal Raman amplified by the pump light multiplexing unit 319 is output to the optical fiber transmission line.

According to the optical amplifier 31 configured as described above, it is possible to perform broadband and high-quality optical amplification relay in optical amplification relay using optical parametric amplification. Specifically, the optical amplifier 31 performs optical parametric amplification on the input optical signal and controls the gain so as to power-shift the optimum input optical power in the optical fiber transmission line to a region where the output of the optical parametric amplification unit is linear amplification. As described above, in the optical amplifier 31, the Raman amplification is applied and the optical parametric amplifier is shifted to the region where the linear amplification output can be performed (in the case of the distributed Raman amplification), and thereby, the optical amplification relay transmission of the broadband and high-quality wavelength multiplexed signal can be achieved in the optical amplification repeater using the optical parametric amplification.

### Second Embodiment

In a second embodiment, a configuration in which the first embodiment is applied to an optical transmission system as an optical amplification repeater will be described. In this case, the optical amplifier includes a configuration for backward pump Raman amplification using an optical fiber transmission line connected to an input side of the optical amplifier as an amplification medium, in addition to the configuration of the first embodiment.

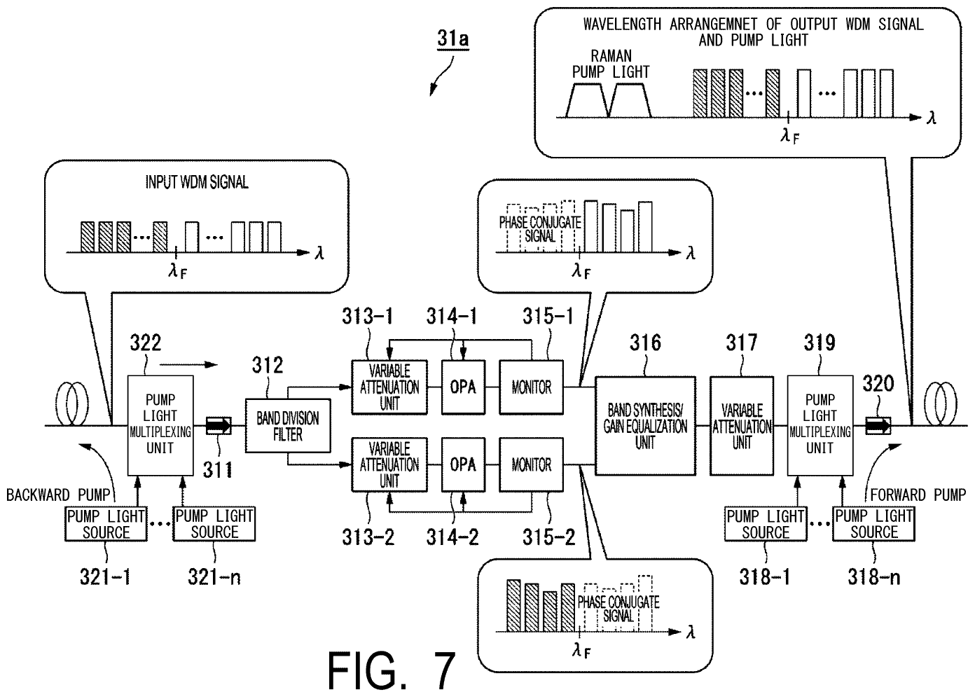

FIG. 7 is a diagram illustrating an exemplary configuration of an optical amplifier 31a in a second embodiment. The optical amplifier 31a includes an optical isolator 311, a band division filter 312, a plurality of variable attenuation units 313-1,313-2, a plurality of OPAs 314-1,314-2, a plurality of monitors 315-1,315-2, a band synthesis/gain equalization unit 316, a variable attenuation unit 317, a plurality of pump light sources 318-1 to 318-n (n is an integer of 2 or more), a pump light multiplexing unit 319, an optical isolator 320, a plurality of pump light sources 321-1 to 321-n, and a pump light multiplexing unit 322.

The optical amplifier 31a is different from the optical amplifier 31 in that the plurality of pump light sources 321-1 to 321-n and the pump light multiplexing unit 322 are newly provided. Other configurations of the optical amplifier 31a are similar to those of the optical amplifier 31. Therefore, differences based on the plurality of pump light sources 321-1 to 321-n and the pump light multiplexing unit 322 will be described.

In the second embodiment, the basic operation is equivalent to that of the first embodiment, but in the Raman amplification of the backward pump, the RIN transfer is very small. Therefore, as the pump light sources 321-1 to 321-n, those in a wavelength band shifted to a short wavelength side of about 100 nm with respect to the WDM signal are used, and both a coherent light source and an incoherent light source can be applied. Light sources of multiple wavelengths may be bundled including a light source for polarization multiplexing or secondary pump. The Raman amplification gain of the forward pump is set to the output of the pump light source such that the optimum optical fiber input power is included in the non-gain saturation region of the OPA 314-1 and 314-2. The variable attenuation unit 317 adjusts the input power of the WDM signal to the transmission line optical fiber.

The pump light multiplexing unit 322 combines the pump light output from each of the pump light sources 321-1 to 321-n and the WDM signal.

The gain of the optical amplification repeater is set such that the sum of the forward Raman gain GRF, the gain GOPA by the OPA, and the backward Raman gain GRB is equal to the loss of the transmission line to be relayed.

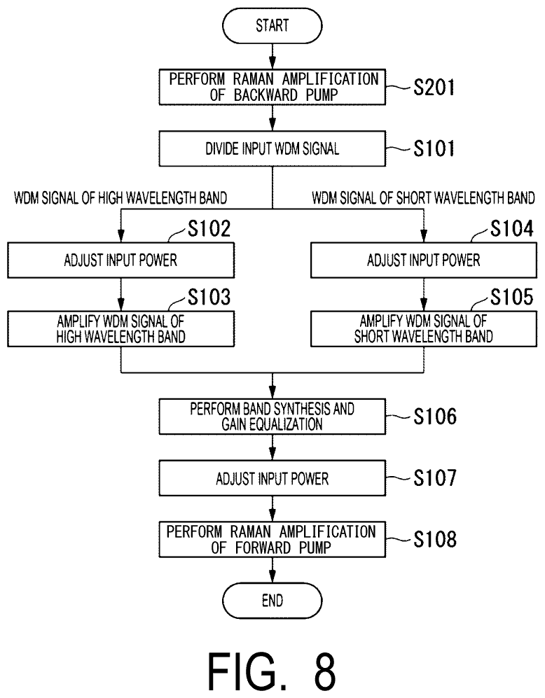

FIG. 8 is a flowchart illustrating a flow of processing performed by the optical amplifier 31a in the second embodiment. In FIG. 8, the same processing steps as those in FIG. 6 will be denoted by the same reference signs as those used in FIG. 6, and description thereof will be omitted.

The pump light multiplexing unit 322 performs Raman amplification of the backward pump by multiplexing the pump light output from each of the pump light sources 321-1 to 321-n and the WDM signal (step S201). The WDM signal Raman amplified by the pump light multiplexing unit 322 is output to the band division filter 312 via the optical isolator 311. Thereafter, the processing in step S101 and subsequent steps is executed.

According to the optical amplifier 31b configured as described above, in the optical amplifier 31b, even when Raman amplification of bidirectional pump is applied, the same effects as those of the first embodiment can be obtained.

According to the optical amplifier 31b, by applying Raman amplification of backward pump to the configuration of the first embodiment, the SNR after transmission can be improved as compared with the first embodiment.

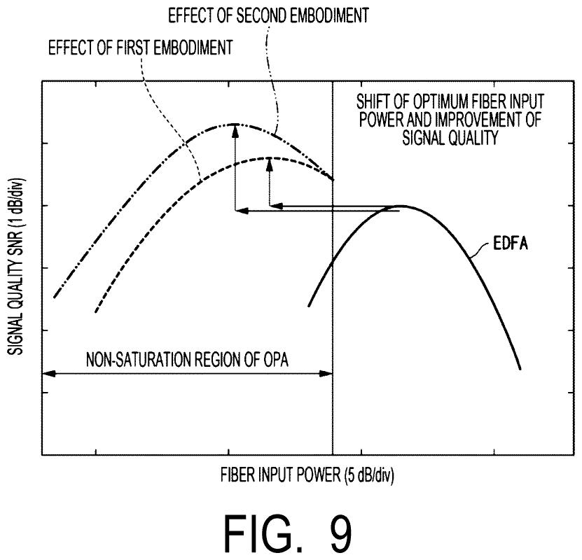

FIG. 9 is a diagram for describing effects in the first embodiment and the second embodiment. As illustrated in FIG. 9, when an attempt is made to achieve fiber input power equivalent to that of a rare-earth doped fiber optical amplification repeater represented by a conventional EDFA only with an optical parametric amplifier, since a signal is distorted due to gain saturation, signal quality after amplification is limited in an amplification band of broadband covered by the OPA. It can be seen that, in the wavelength multiplexing optical transmission system, as compared with the conventional rare-earth doped fiber optical amplification repeater, the configurations illustrated in the first embodiment and the second embodiment enable optical amplification relay transmission of a WDM signal of broadband and high quality.

### Third Embodiment

In the first embodiment and the second embodiment, the configuration in which the optical parametric amplification is performed while the band is divided into two bands has been described. In a third embodiment, a configuration for performing optical parametric amplification in three or more bands will be described. In the third embodiment, a configuration applied as an optical relay node in the case of three bands will be described.

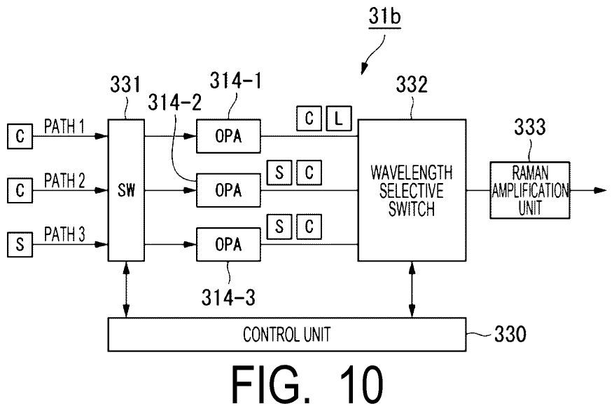

FIG. 10 is a diagram illustrating an exemplary configuration of an optical amplifier 31b in the third embodiment. The optical amplifier 31b includes a control unit 330, a SW 331, a plurality of OPAs 314-1 to 314-3, a wavelength selective switch 332, and a Raman amplification unit 333.

FIG. 10 illustrates an example in which an optical signal is input from the separate paths 1 to 3 to the optical amplifier 31b as a relay node. It is assumed that the optical signal input to the optical amplifier 31b uses a C-band wavelength for the path 1, a C-band wavelength for the path 2, and an S-band wavelength for the path 3.

The OPAs 314-1 to 314-3 are optical parametric amplifiers capable of amplifying a set frequency band. For example, it is assumed that the OPA 314-1 can amplify the C band and the L band, the OPA 314-2 can amplify the S band and the C band, and the OPA 314-3 can amplify the S band and the C band.

The control unit 330 controls the SW 331 and the wavelength selective switch 332. The control of the SW 331 and the wavelength selective switch 332 is switching of a path.

The SW 331 includes a plurality of input ports and a plurality of output ports. The connection relationship between the input port and the output port in the SW 331 is controlled by the control unit 330. In the SW 331, a path connecting the input port and the output port is controlled so as to assign a signal to the OPA 314 capable of amplifying each band. For example, the path connecting the input port and the output port is controlled by the control unit 330 such that the optical signal input from the path 1 is input to the OPA 314-1 capable of amplifying the C-band and the L-band because the optical signal is a C-band optical signal, the optical signal input from the path 2 is input to the OPA 314-2 capable of amplifying the C-band and the S-band because the optical signal is a C-band optical signal, and the optical signal input from the path 3 is input to the OPA 314-3 capable of amplifying the C-band and the S-band because the optical signal is an S-band optical signal.

The wavelength selective switch 332 selects a band such that the bands amplified by the OPA 314-1 to 314-3 do not collide with each other. In the example illustrated in FIG. 10, the wavelength selective switch 332 selects an L-band optical signal from the output of the OPA 314-1, a C-band optical signal from the output of the OPA 314-2, and an S-band optical signal from the output of the OPA 314-3. The wavelength selective switch 332 multiplexes the optical signals of the selected respective bands.

The Raman amplification unit 333 multiplexes the optical signal multiplexed by the wavelength selective switch 332 and the pump light having an appropriate wavelength, and amplifies the optical signal to the optimum input power of the transmission line fiber input. As a result, when the OPA operates in an output region of saturation power or less, broadband and high-quality optical relay amplification can be achieved. An amplification fiber may be used.

Although the embodiments of the present invention have been described in detail with reference to the drawings, a specific configuration is not limited to the embodiments, and includes design and the like without departing from the spirit of the present invention.

### INDUSTRIAL APPLICABILITY

The present invention can be applied to an optical repeater in an optical transmission system.

### REFERENCE SIGNS LIST

10-1 to 10-N Optical transmitter
20 Optical multiplexer/demultiplexer
30 Optical amplification relay transmission line
40 Optical multiplexer/demultiplexer
50-1 to 50-N Optical receiver
31 Optical amplifier
32 Optical parametric amplification unit
33, 318-1 to 318-n, 321-1 to 321-n Pump light source
34 Raman amplification pump light multiplexing unit
35, 311, 320 Optical isolator
312 Band division filter
313-1, 313-2, 317 Variable attenuation unit
314-1, 314-2 OPA
315-1, 315-2 Monitor
316 Band synthesis/gain equalization unit
319, 322 Pump light multiplexing unit
330 Control unit
331 SW
332 Wavelength selective switch
333 Raman amplification unit

1. An optical amplifier that optically amplifies and relays an optical signal transmitted through an optical fiber transmission line, the optical amplifier comprising:
an optical parametric amplifier configured to perform optical parametric amplification on an input optical signal; and
a Raman amplifier configured to control a gain so as to power-shift optimum input optical power in the optical fiber transmission line to a region where an output of the optical parametric amplifier is linear amplification.

2. The optical amplifier according to claim 1,
wherein a multiplexed signal obtained by wavelength multiplexing is input to the optical amplifier, and
the optical parametric amplifier is a first optical parametric amplifier and a second optical parametric amplifier,
the optical amplifier further comprises:
a band division filter configured to divide the multiplexed signal that has been input, into an optical signal of a long wavelength band and an optical signal of a short wavelength band with reference to a basic wavelength;
a first variable attenuator configured to adjust light intensity of the optical signal of the long wavelength band;
a second variable attenuator configured to adjust light intensity of the optical signal of the short wavelength band; and
a band synthesizer configured to multiplex the optical signal of the long wavelength band after amplification and the optical signal of the short wavelength band after amplification,
the first optical parametric amplifier performs optical parametric amplification on the optical signal of the long wavelength band whose light intensity has been adjusted by the first variable attenuator, and
the second optical parametric amplifier performs optical parametric amplification on the optical signal of the short wavelength band whose light intensity has been adjusted by the second variable attenuator.

3. The optical amplifier according to claim 2, further comprising:
a backward Raman amplifier that is provided in a preceding stage of the band division filter and performs Raman amplification of backward pump using the optical fiber transmission line as an amplification medium.

4. The optical amplifier according to claim 2, further comprising:
a first monitor configured to monitor output power of the first optical parametric amplifier and outputs a monitoring result to the first variable attenuator and the first optical parametric amplifier; and
a second monitor configured to monitor output power of the second optical parametric amplifier and outputs a monitoring result to the second variable attenuator and the second optical parametric amplifier,
wherein the first variable attenuator adjusts an attenuation amount based on the monitoring result output from the first monitor,
the first optical parametric amplifier controls a pump light level based on the monitoring result output from the first monitor,
the second variable attenuator adjusts an attenuation amount based on the monitoring result output from the second monitor, and
the second optical parametric amplifier controls a pump light level based on the monitoring result output from the second monitor.

5. The optical amplifier according to claim 1,
wherein the optical parametric amplifier is a plurality of optical parametric amplifiers,
the optical amplifier further comprises:
a switch including a plurality of input ports and a plurality of output ports; and
a wavelength selective switch configured to select a frequency band to be multiplexed among frequency bands of optical signals output from the plurality of optical parametric-amplifiers,
the optical parametric amplifiers are respectively connected to the output ports of the switch, and
the switch outputs an optical signal to an output port of the output ports to which an optical parametric amplifier of the optical parametric amplifiers capable of amplifying a frequency band of the optical signal is connected for each optical signal input to each of the input ports.

6. An optical amplification method in an optical amplifier that optically amplifies and relays an optical signal transmitted through an optical fiber transmission line, the optical amplification method comprising:
performing optical parametric amplification on an input optical signal by an optical parametric amplifier; and
controlling a gain so as to power-shift optimum input optical power in the optical fiber transmission line to a region where an output of the optical parametric amplifier is linear amplification.
